(19) United States
(12) Patent Application Publication
(10) Pub. No.: US 2024/0283277 A1
(43) Pub. Date: Aug. 22, 2024

(54) TEMPERATURE COMPENSATION METHOD AND APPARATUS BASED ON DIRECT CURRENT CHARGING BASE

(71) Applicant: JILIN ZHONG YING HIGH TECHNOLOGY CO., LTD., Changchun (CN)

(72) Inventors: Chao WANG, Changchun (CN); Jimin WANG, Changchun (CN)

(21) Appl. No.: 18/571,925

(22) PCT Filed: Jul. 21, 2022
(86) PCT No.: PCT/CN2022/107009

§ 371 Date: Dec. 19, 2023

(30) Foreign Application Priority Data
Jul. 23, 2021 (CN) 202110839832.2

(51) Int. Cl. H02J 7/00; B60L 53/16; B60L 53/60

(52) U.S. Cl. CPC H02J 7/007192; B60L 53/16; B60L 53/60; H02J 7/00304

(57) ABSTRACT

The present disclosure discloses a method and an apparatus for temperature compensation based on a direct current charging base, and the method includes: collecting a temperature of a direct current charging-base terminal; calculating temperature compensation function coefficients corresponding to different current values; and obtaining a corrected temperature based on the collected temperature of the direct current charging-base terminal, the temperature compensation function coefficients corresponding to the different current values and a pre-constructed temperature compensation function, and the corrected temperature is sent to a charging controller of an electric vehicle. The present disclosure realizes compensation of temperature errors caused by temperature transmission delay during charging of electric vehicles, thereby realizing safe, accurate and rapid charging of vehicles.

### CROSS-REFERENCE TO RELATED APPLICATION

The present application is a National Phase Entry of International Application No. PCT/CN2022/107009, filed Jul. 21, 2022, and claims the priority of the Chinese Patent Application No. 202110839832.2, entitled “Method and Apparatus for Temperature Compensation Based on Direct Current Charging Base”, filed on Jul. 23, 2021, all of which are incorporated herein by reference in their entireties.

### TECHNICAL FIELD

The present disclosure relates to the technical field of direct current charging of electric vehicles, in particular to a method and apparatus for temperature compensation based on a direct current charging base.

### BACKGROUND

This part aims to provide background or context for the embodiments of the present disclosure as set forth in the claims. The description here is not acknowledged as prior art just because it is included in this part.

With the development of new energy vehicles, to charge the vehicle end safely, accurately and rapidly has become a new market demand. Currently, however, safe, accurate and rapid charging for electric vehicles cannot be ensured because the temperature transmission delay in the charging process will cause temperature errors, resulting in that the collected temperatures of the direct current charging-base terminal are not accurate.

### SUMMARY

The embodiments of the present disclosure provide a method for temperature compensation based on a direct current charging base, for compensating a temperature error caused by temperature transmission delay, the method including:

collecting a temperature of a direct current charging-base terminal;

calculating temperature compensation function coefficients corresponding to different current values;

obtaining a corrected temperature based on the collected temperature of the direct current charging-base terminal, the temperature compensation function coefficients corresponding to the different current values and a pre-constructed temperature compensation function, and the corrected temperature being sent to a charging controller of an electric vehicle.

The embodiments of the present disclosure also provide a device for temperature compensation based on a direct current charging base, for compensating a temperature error caused by temperature transmission delay, the device including:
a temperature collection unit, configured to collect a temperature of a direct current charging-base terminal;
a coefficient calculation unit, configured to calculate temperature compensation function coefficients corresponding to different current values;
a compensation unit, configured to obtain a corrected temperature based on the collected temperature of the direct current charging-base terminal, the temperature compensation function coefficients corresponding to the different current values and a pre-constructed temperature compensation function, the corrected temperature is sent to a charging controller of an electric vehicle.

The embodiments of the present disclosure also provide a computer device, including a memory, a processor, and a computer program stored on the memory and capable of running on the processor, and the processor implements the above-mentioned method for temperature compensation based on a direct current charging base when executing the computer program.

The embodiments of the present disclosure also provide a computer readable storage medium which stores a computer program configured to execute the above-mentioned method for temperature compensation based on a direct current charging base.

Compared with the technical solution of the prior art in which safe, accurate and rapid charging of electric vehicles cannot be ensured because the temperature transmission delay in the charging process will cause temperature errors, resulting in that the collected temperatures of the direct current charging-base terminal are not accurate, the solution of temperature compensation based on a direct current charging base in the embodiments of the present disclosure realizes compensation for the temperature errors caused by temperature transmission delay during charging of electric vehicles, thereby achieving safe, accurate and rapid charging of the vehicles, by collecting a temperature of a direct current charging-base terminal; calculating temperature compensation function coefficients corresponding to different current values; and obtaining a corrected temperature based on the collected temperature of the direct current charging-base terminal, the temperature compensation function coefficients corresponding to the different current values and a pre-constructed temperature compensation function, and the corrected temperature is sent to a charging controller of an electric vehicle.

### BRIEF DESCRIPTION OF THE DRAWINGS

The drawings described here are intended to provide further explanation of the present disclosure and constitute a part of the present application, but do not limit to the present disclosure. In the drawings:

FIG. 1 is a schematic diagram illustrating the delay and deviation in phase and amplitude between the temperature measured by the temperature sensor and the actual temperature of the terminal according to an embodiment of the present disclosure;

FIG. 2 is a flow chart of a method for temperature compensation based on a direct current charging base according to an embodiment of the present disclosure;

FIG. 3 is a schematic diagram illustrating the principle of temperature compensation based on a direct current charging base according to an embodiment of the present disclosure;

FIG. 4 is a flow chart of a method for temperature compensation based on a direct current charging base according to another embodiment of the present disclosure;

FIG. 5 is a schematic diagram illustrating the determination of coefficient values by fitting with MATLAB when the charging current is 200 A according to an embodiment of the present disclosure;

FIG. 6 is a structure diagram illustrating the apparatus for temperature compensation based on a direct current charging base according to an embodiment of the present disclosure;

FIG. 7 is a structure diagram illustrating the temperature collection unit according to an embodiment of the present disclosure.

### DETAILED DESCRIPTION

In order to make the object, technical solutions and advantages of the present disclosure clearer, detail descriptions will be described now be described with reference to the drawings. Here, the exemplary embodiments of the present disclosure and descriptions thereof are used for explaining the present disclosure, not for limiting the present disclosure.

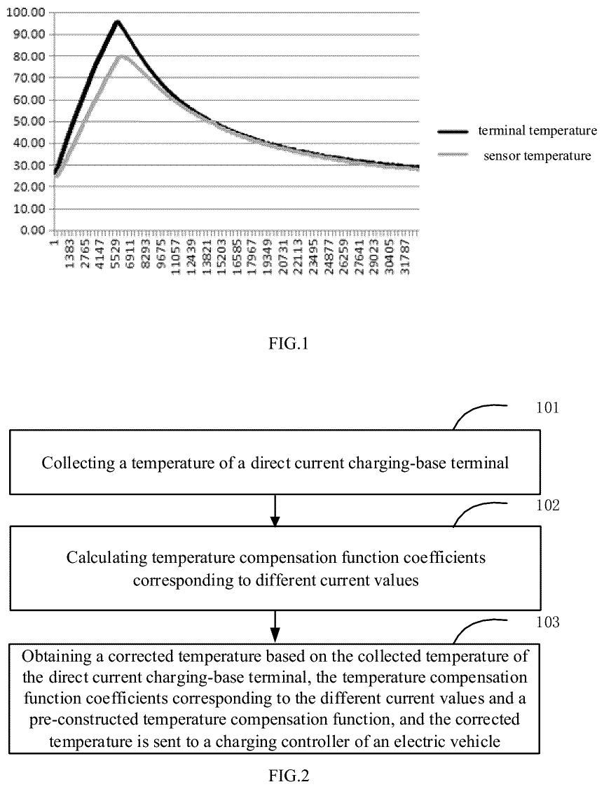

The inventor has found a technical problem: in the direct current charging base, the temperature of the white terminal is measured by the temperature sensor, the temperature sensor is located very close to the terminal but not directly attached to the surface of the terminal, and thus delay and loss are caused when the temperature of the terminal is transmitted to the temperature sensor. As shown in FIG. 1, there is delay and deviation in both phase and amplitude between the temperature measured by the temperature sensor and the actual temperature of the terminal.

Taking into account the above-mentioned technical problem, the inventor proposes a solution of temperature compensation based on a direct current charging base. This solution is a solution of adjusting and compensating an error in temperature caused by temperature transmission delay in the charging process, thereby ensuring safe, accurate and rapid charging of electric vehicles. The solution of temperature compensation based on a direct current charging base is described in detail below.

FIG. 2 is a flow chart of a method for temperature compensation based on a direct current charging base according to an embodiment of the present disclosure. As shown in FIG. 2, the method includes the following steps:

Step 101: collecting a temperature of a direct current charging-base terminal;

Step 102: calculating temperature compensation function coefficients corresponding to different current values;

Step 103: obtaining a corrected temperature based on the collected temperature of the direct current charging-base terminal, the temperature compensation function coefficients corresponding to the different current values and a pre-constructed temperature compensation function, and the corrected temperature is sent to a charging controller of an electric vehicle.

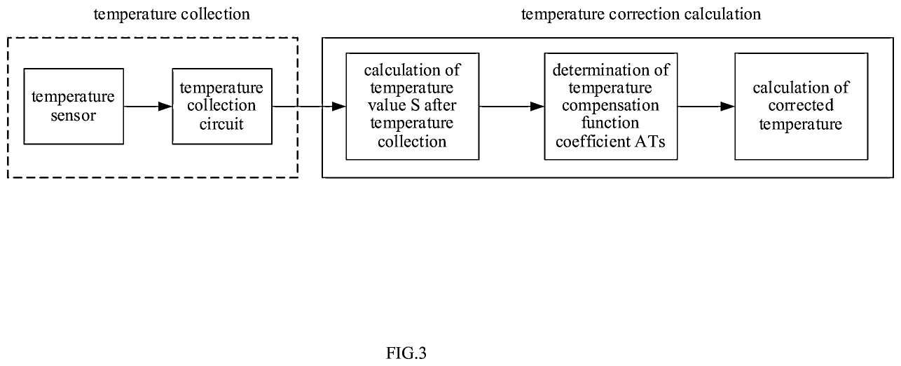

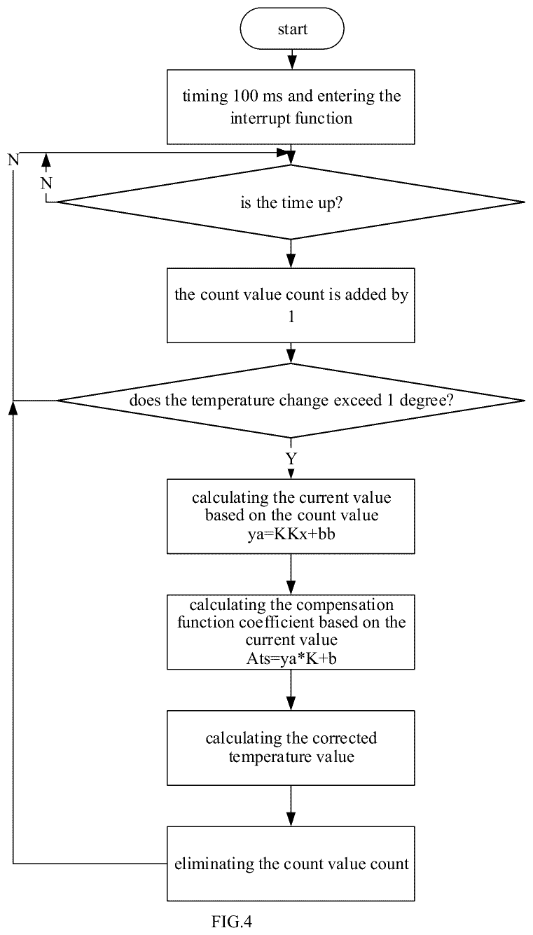

The method for temperature compensation based on a direct current charging base provided in the embodiment of the present disclosure adjusts the error in temperature caused by temperature transmission and loss by differentiation and lag compensator of a software, and ensures that the corrected temperature is accurate and reliable, thereby achieving safe, accurate and rapid charging of vehicles. The steps involved in this method are described in detail below in combination with FIGS. 3-7.

As shown in FIG. 3, the temperature processing process mainly includes following three parts: (1) temperature collection; (2) calculation of temperature compensation function coefficients ATs based on current values; (3) determination of a delay (temperature) compensation function. Specific descriptions are as follows:

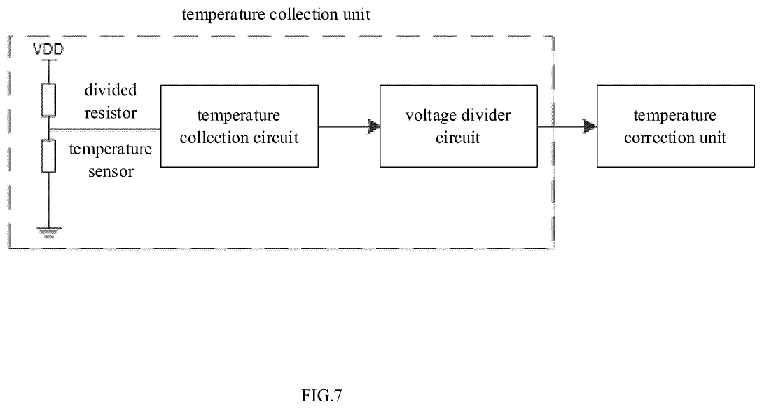

(1) Temperature collection, i.e. the detailed embodiment of the Step 101: in the embodiment of the present disclosure, for the collected temperature of the direct current charging-base terminal, the voltage is subjected to voltage division through a temperature sensor and a divided resistor, and becomes a different voltage after isolation amplification, and then enters a single-chip microcontroller (a temperature correction unit, i.e. the compensation unit described below), and a temperature value S of the voltage corresponding to the temperature sensor is obtained by table look-up (the relationship between voltage and temperature), and the block diagram of the hardware circuit (temperature collection circuit) is shown in FIG. 7. The advantage of performing voltage division through a temperature sensor and a resistance and forming different voltages after isolation amplification is that the interference of the front signal is isolated, the resistance signal is changed into a voltage signal that is easy to collect by the single-chip microcontroller, and thus the safety and accuracy of charging are further improved.

It can be seen from above that, in one embodiment, collecting the temperature of the direct current charging-base terminal includes collecting the temperature of the direct current charging-base terminal using a temperature collection unit including:
a divided resistor, a first end of which is connected to a 5V voltage end converted from a 12V voltage of the vehicle end;
a temperature sensor, a first end of which is connected to a second end of the divided resistor and a second end of the temperature sensor is grounded, to collect a voltage signal of the direct current charging-base terminal;
a temperature collection circuit, an input end of which is connected to the first end of the temperature sensor, so as to isolate the voltage signal collected by the temperature sensor and obtain a voltage after isolation processing;
a voltage divider circuit, an input end of which is connected to an output end of the temperature collection circuit, for converting the voltage after isolation processing into an effective voltage signal that is easy to collect; the effective voltage signal that is easy to collect is configured to determine a temperature value corresponding to the voltage collected by the temperature sensor based on the pre-constructed relationship between voltage and temperature, and the temperature value is taken as the temperature of the direct current charging-base terminal.

In specific implementation, the temperature obtained by the temperature collection unit is more accurate, so that the accuracy and safety of temperature compensation for the direct current charging base is further improved.

(2) Calculation of compensation function coefficients ATs based on current values: the current range of flowing through the charging-base terminal is 100 A-500 A. For different currents, the squared value of the current is in direct proportional to the increase in temperature. The current value is made in direct proportional to the differential value of temperature by way of calculating the differential. Finally, there is a correspondence relationship between the ATs and the temperature rise rate. However, due to the non-linearity of the temperature rise rates corresponding to the currents in different segments in the calibration process, the currents obtained by different temperature rise rates after subsequent segmentation have different KK, bb, and thus the K, b corresponding to the ATs subsequently obtained based on different currents are also different. The advantage of making the current value in direct proportion to the differential value of temperature is that, when the external conditions are not changed, the current value is determined to be in a linear relationship with the temperature rise rate, the differential value of temperature=temperature difference/time difference, the differential value of temperature corresponds to the slope of temperature rise over a period of time (temperature rise rate, temperature change rate), and by actually measuring the slope K1 of temperature rise under 100 A and the slope K2 of temperature rise under 500 A, the different current values ya corresponding to the slopes x of different temperature rises can be calculated using the linear formula y=KKx+bb, where, KK=(500−100)/(k2−k1), bb is a constant, y is the current value ya corresponding to the slopes of different temperature rises. The ATs is determined by the coefficient obtained after fitting the tested temperature curve corresponding to the actual fixed charging current to a standard temperature with MATLAB. When the current is 500 A, the corresponding ATs is set as ATs-500, and when the current is 100 A, the corresponding ATs is set as ATs-100. Therefore, the delay compensated ATs under different currents ya satisfy the correspondence relationship formula: ATs=ya×K+b, where, K=((ATs−500)−(ATs−100))/(500−100), where, ATs is the temperature compensation function coefficient, ya is the current value, and K and b are constants determined by actual measurement. For accuracy of measurement, different K and b coefficients are calculated using the same formula for the over-limit current of 500 A-700 A and the current of 50 A-100 A below the working current, and separate correction is performed to calculate different ATs.

It can be seen from above that, in one embodiment, the calculating the temperature compensation function coefficients corresponding to the different current values may include:
making a current value in direct proportion to a differential value of a temperature, and calculating different current values corresponding to different temperature rise rates; and
determining the temperature compensation function coefficients corresponding to the different current values based on the different current values corresponding to the different temperature rise rates.

It can be seen from above that, in one embodiment, calculating the temperature compensation function coefficients corresponding to the different current values may include calculating the temperature compensation function coefficients corresponding to different current values using a formula including:

$$ATs = ya \times K + b$$

where, K=((ATs−500)−(ATs−100))/(500−100), ATs is the temperature compensation function coefficient, ya is the current value, and K and b are constants.

It can be seen from above that, in one embodiment, different K and b is calculated based on the over-limit current range of 500 A-700 A and the range of 50 A-100 A below the working current.

(3) Determination of a delay (temperature) compensation function: in the testing process, due to the transmission delay and loss of temperature, the temperature is compensated. The formula for compensation is a first-order delay function formula as follows: y2=(1+Ts×S)/(1+Ats×S). In this formula, Ts is a constant, ATs is a variable in direct proportional to the current in the process of temperature rise, S is a current sampling temperature value (the temperature of the direct current charging-base terminal), where, the Ts and ATs are determined by the coefficient obtained after fitting the tested temperature curve corresponding to the actual fixed charging current to a standard temperature with MATLAB, the parameter Ts is fixed, and different ATs values corresponding to different currents are obtained, and the different ATs values are retrieved corresponding to different temperature change rates in the delay compensation calculation. FIG. 5 is a schematic diagram illustrating the determination of the coefficient value by fitting with MATLAB when the charging current is 200 A.

(4) The flow chart of the whole temperature correction is shown in FIG. 4. The temperature-corrected value (the corrected temperature) is sent via a CAN cable to a charge controller CCU of a vehicle, and the charge controller CCU of the vehicle may safely, accurately and rapidly charge the electric vehicle by using the corrected temperature.

In the specific implementation, on the basis that the sampling temperature, the temperature compensation function and the temperature compensation function coefficients are determined, the final corrected temperature is determined using the temperature correction formula, and the corrected temperature is sent to the charge controller of the electric vehicle.

In conclusion, the embodiments of the present disclosure realize the following: the vehicle is charged stably and rapidly; the errors are corrected simply and rapidly using software, that is, the sampling temperature values under different currents are corrected simply, rapidly and practically by differentiation and lag correction of software.

The embodiments of the present disclosure have the following advantageous technical effect: the method for temperature compensation based on a direct current charging base provided in the embodiments of the present disclosure realizes the compensation of temperature errors caused by temperature transmission delay during charging of electric vehicles, thereby realizes safe, accurate and rapid charging of the vehicles.

The embodiments of the present disclosure also provide an apparatus for temperature compensation based on a direct current charging base, as described in the following embodiment. Since the principle of solving the problem of the apparatus is similar to that of the method for temperature compensation based on a direct current charging base, reference can be made to the implementation of the method for temperature compensation based on a direct current charging base for the implementation of the apparatus, and the detailed descriptions will not be repeated here.

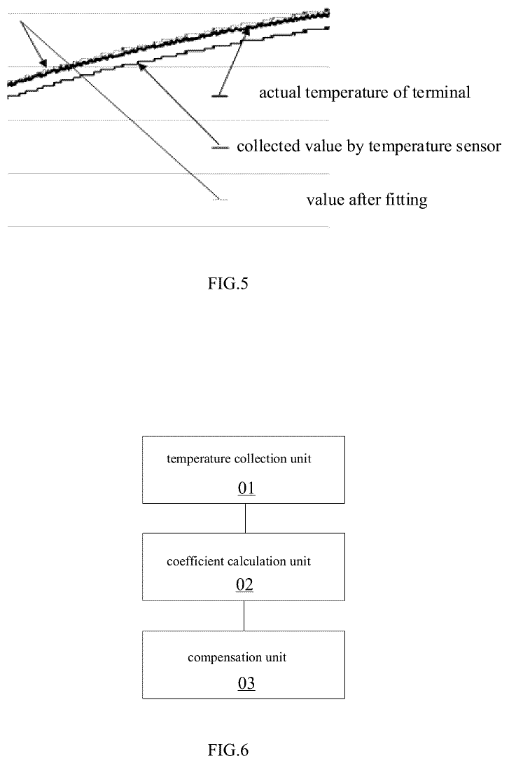

FIG. 6 is a schematic diagram illustrating the structure of the apparatus for temperature compensation based on a direct current charging base in an embodiment of the present disclosure, the apparatus including:
a temperature collection unit 01, configured to collect a temperature of a direct current charging-base terminal;
a coefficient calculation unit 02, configured to calculate temperature compensation function coefficients corresponding to different current values;
a compensation unit 03, configured to obtain a corrected temperature based on the collected temperature of the direct current charging-base terminal, the temperature compensation function coefficients corresponding to the different current values and a pre-constructed temperature compensation function, and the corrected temperature is sent to a charging controller of an electric vehicle.

In one embodiment, as shown in FIG. 7, the temperature collection unit may include:
a divided resistor, a first end of which is connected to a 5V voltage end converted from a 12V voltage of the vehicle end;
a temperature sensor, a first end of which is connected to a second end of the divided resistor and a second end is grounded, to collect a voltage signal of the direct current charging-base terminal;
a temperature collection circuit, an input end of which is connected to the first end of the temperature sensor, for isolating the voltage signal collected by the temperature sensor and obtain a voltage after isolation processing;
a voltage divider circuit, an input end of which is connected to an output end of the temperature collection circuit, for converting the voltage after isolation processing into an effective voltage signal that is easy to collect; the effective voltage signal that is easy to collect is configured to determine a temperature value corresponding to the voltage collected by the temperature sensor based on a pre-constructed relationship between voltage and temperature, and the temperature value is taken as the temperature of the direct current charging-base terminal.

In one embodiment, the coefficient calculation unit may be specifically configured to:
make a current value in direct proportion to a differential value of temperature, and calculating different current values corresponding to different temperature rise rates; and
determine temperature compensation function coefficients corresponding to the different current values based on the different current values corresponding to the different temperature rise rates.

In one embodiment, the coefficient calculation unit may be specifically configured to calculate the temperature compensation function coefficients corresponding to the different current values using a formula including:

$$ATs = ya \times K + b$$

where, ATs is the temperature compensation function coefficient, ya is the current value, and K and b are constants.

In one embodiment, different K and b are calculated based on the over-limit current range of 500 A-700 A and the range of 50 A-100 A below the working current.

The embodiments of the present disclosure also provide a computer device, including a memory, a processor, and a computer program stored on the memory and capable of running on the processor, and the above-mentioned method for temperature compensation based on a direct current charging base is implemented when the processor executes the computer program.

The embodiments of the present disclosure also provide a computer readable storage medium which stores a computer program that implements the above-mentioned method for temperature compensation based on a direct current charging base.

Compared with the technical solution of the prior art in which safe, accurate and rapid charging of electric vehicles cannot be ensured because the temperature transmission delay in the charging process will cause temperature errors, resulting in that the collected temperatures of the direct current charging-base terminal are not accurate, the solution of temperature compensation based on a direct current charging base in the embodiments of the present disclosure realizes compensation for the temperature errors caused by temperature transmission delay during charging of electric vehicles, thereby achieving safe, accurate and rapid charging of the vehicles, by collecting a temperature of a direct current charging-base terminal; calculating temperature compensation function coefficients corresponding to different current values; and obtaining a corrected temperature based on the collected temperature of the direct current charging-base terminal, the temperature compensation function coefficients corresponding to the different current values and a pre-constructed temperature compensation function, and the corrected temperature is sent to a charging controller of an electric vehicle.

The persons skilled in the art shall understand that the embodiments of the present disclosure may be provided as a method, a system, or a computer program product. Therefore, the present disclosure may take the form of a complete hardware embodiment, a complete software embodiment, or an embodiment of a combination of software and hardware. Moreover, the present disclosure may take the form of a computer program product implemented on one or more computer available storage medium (including, but not limited to, disk memory, CD-ROM, optical memory, etc.) including computer-available program codes.

The present disclosure is described with reference to the flow charts and/or block diagrams of the method, apparatus (system) and computer program product according to the embodiments of the present disclosure. It should be understood that each process and/or block in the flow chart and/or block diagram, as well as the combination of the processes and/or blocks in the flow chart and/or block diagram, may be implemented by computer program instructions. These computer program instructions may be provided to the processor of a general-purpose computer, a specialized computer, an embedded processing machine, or other programmable data processing devices to produce a machine such that the instructions executed by the processor of the computer or other programmable data processing devices produce a device for implementing the functions specified in one or more processes in the flow chart and/or one or more blocks in the block diagram.

These computer program instructions may also be stored in a computer readable memory capable of directing a computer or other programmable data processing devices to work in a particular manner such that the instructions stored in the computer readable memory produce a manufactured product including an instructing device that implements the functions specified in one or more processes in the flow chart and/or one or more blocks in the block diagram.

These computer program instructions may also be loaded onto a computer or other programmable data processing devices such that a series of operation steps are performed on the computer or other programmable devices to produce computer-implemented processing, so that the instructions executed on the computer or other programmable devices provide steps for implementing the functions specified in one or more processes in the flow chart and/or one or more blocks in the block diagram.

The above-mentioned specific embodiments further explain the object, technical solutions and advantageous effects of the present disclosure. It should be understood that the above is merely the specific embodiments of the present disclosure, and is not used to limit the protection scope of the present disclosure. Any amendments, equivalent substitutions, improvements, etc. within the spirit and principle of the present disclosure should be included in the protection scope of the present disclosure.

1. A method for temperature compensation based on a direct current charging base, wherein the method comprises:
collecting a temperature of a direct current charging-base terminal;
calculating temperature compensation function coefficients corresponding to different current values;
obtaining a corrected temperature based on the collected temperature of the direct current charging-base terminal, the temperature compensation function coefficients corresponding to the different current values, and a pre-constructed temperature compensation function, and the corrected temperature is sent to a charging controller of an electric vehicle.

2. The method for temperature compensation based on a direct current charging base according to claim 1, wherein the collecting the temperature of a direct current charging-base terminal comprises collecting the temperature of a direct current charging-base terminal using a temperature collection units comprising:
a divided resistor, a first end of which is connected to a voltage end of a vehicle;
a temperature sensor, a first end of which is connected to a second end of the divided resistor and a second end is grounded, to collect a voltage signal of the direct current charging-base terminal;
a temperature collection circuit, an input end of which is connected to the first end of the temperature sensor, so as to isolate the voltage signal collected by the temperature sensor and obtain a voltage after isolation processing; and
a voltage divider circuit, an input end of which is connected to an output end of the temperature collection circuit, for converting the voltage after isolation processing into an effective voltage signal that is easy to collect, the effective voltage signal that is easy to collect is configured to determine a temperature value corresponding to the voltage collected by the temperature sensor based on a pre-constructed relationship between voltage and temperature, and the temperature value is taken as the temperature of the direct current charging-base terminal.

3. The method for temperature compensation based on a direct current charging base according to claim 1, wherein the calculating the temperature compensation function coefficients corresponding to the different current values comprises:
making a current value in direct proportion to a differential value of a temperature, and calculating different current values corresponding to different temperature rise rates; and
determining the temperature compensation function coefficients corresponding to the different current values based on the different current values corresponding to the different temperature rise rates.

4. The method for temperature compensation based on a direct current charging base according to claim 3, wherein the calculating the temperature compensation function coefficients corresponding to the different current values comprises calculating the temperature compensation function coefficients corresponding to the different current values by a formula comprising:
$$ATs = ya \times K + b$$
where, ATs is the temperature compensation function coefficient, ya is the current value, and K and b are constants.

5. The method for temperature compensation based on a direct current charging base according to claim 4, wherein the different K and b are calculated based on an over-limit current range of 500 A-700 A and a range of 50 A-100 A below a working current.

6. A apparatus for temperature compensation based on a direct current charging base, wherein the apparatus comprises:
a temperature collection unit configured to collect a temperature of a direct current charging-base terminal;
a coefficient calculation unit configured to calculate temperature compensation function coefficients corresponding to different current values; and
a compensation unit configured to obtain a corrected temperature based on the collected temperature of the direct current charging-base terminal, the temperature compensation function coefficients corresponding to the different current values and a pre-constructed temperature compensation function, and the corrected temperature is sent to a charging controller of an electric vehicle.

7. The apparatus for temperature compensation based on a direct current charging base according to claim 6, wherein the temperature collection unit comprises:
a divided resistor, a first end of which is connected to a voltage end of a vehicle;
a temperature sensor, a first end of which is connected to a second end of the divided resistor and a second end is grounded, to collect a voltage signal of the direct current charging-base terminal;
a temperature collection circuit, an input end of which is connected to the first end of the temperature sensor, for isolating the voltage signal collected by the temperature sensor and obtain a voltage after isolation processing;
a voltage divider circuit, an input end of which is connected to an output end of the temperature collection circuit, for converting the voltage after isolation processing into an effective voltage signal that is easy to collect, the effective voltage signal that is easy to collect is configured to determine a temperature value corresponding to the voltage collected by the temperature sensor based on a pre-constructed relationship between voltage and temperature, and the temperature value is taken as the temperature of the direct current charging-base terminal.

8. The apparatus for temperature compensation based on a direct current charging base according to claim 6, wherein the coefficient calculation unit is specifically configured to:
make a current value in direct proportion to a differential value of temperature, and calculating different current values corresponding to different temperature rise rates; and
determine the temperature compensation function coefficients corresponding to the different current values based on the different current values corresponding to the different temperature rise rates.

9. The apparatus for temperature compensation based on a direct current charging base according to claim 8, wherein the coefficient calculation unit is specifically configured to calculate the temperature compensation function coefficients corresponding to the different current values by a formula comprising:
$$ATs = ya \times K + b$$
where, ATs is the temperature compensation function coefficient, ya is the current value, and K and b are constants.

10. The apparatus for temperature compensation based on a direct current charging base according to claim 9, wherein the different K and b are calculated based on an over-limit current range of 500 A-700 A and a range of 50 A-100 A below a working current.

11. A computer device, comprising a memory, a processor, and a computer program stored on the memory and capable of running on the processor, wherein the processor implements the method according to claim 1 when executing the computer program.

12. (canceled)

13. The computer device according to claim 11, wherein the collecting the temperature of a direct current charging-base terminal comprises collecting the temperature of a direct current charging-base terminal using a temperature collection units comprising:
a divided resistor, a first end of which is connected to a voltage end of a vehicle;
a temperature sensor, a first end of which is connected to a second end of the divided resistor and a second end is grounded, to collect a voltage signal of the direct current charging-base terminal;
a temperature collection circuit, an input end of which is connected to the first end of the temperature sensor, so as to isolate the voltage signal collected by the temperature sensor and obtain a voltage after isolation processing; and
a voltage divider circuit, an input end of which is connected to an output end of the temperature collection circuit, for converting the voltage after isolation processing into an effective voltage signal that is easy to collect, the effective voltage signal that is easy to collect is configured to determine a temperature value corresponding to the voltage collected by the temperature sensor based on a pre-constructed relationship between voltage and temperature, and the temperature value is taken as the temperature of the direct current charging-base terminal.

14. The computer device according to claim 11, wherein the calculating the temperature compensation function coefficients corresponding to the different current values comprises:
making a current value in direct proportion to a differential value of a temperature, and calculating different current values corresponding to different temperature rise rates; and
determining the temperature compensation function coefficients corresponding to the different current values based on the different current values corresponding to the different temperature rise rates.

15. The computer device according to claim 14, wherein the calculating the temperature compensation function coefficients corresponding to the different current values comprises calculating the temperature compensation function coefficients corresponding to the different current values by a formula comprising:
$$ATs = ya \times K + b$$
where, ATs is the temperature compensation function coefficient, ya is the current value, and K and b are constants.

16. The computer device according to claim 15, wherein the different K and b are calculated based on an over-limit current range of 500 A-700 A and a range of 50 A-100 A below a working current.
